(19) United States
(12) Patent Application Publication
(10) Pub. No.: US 2015/0292299 A1
(43) Pub. Date: Oct. 15, 2015

(54) INDUCTION APPARATUS FOR HEATING AN OIL RESERVOIR

(71) Applicant: SIEMENS AKTIENGESELLSCHAFT, München (DE)

(72) Inventors: Stefan Blendinger, Furth (DE); Andreas Koch, Neunkirchen am Brand (DE)

(73) Assignee: SIEMENS AKTIENGESELLSCHAFT, Munchen (DE)

(21) Appl. No.: 14/441,397

(22) PCT Filed: Sep. 16, 2013
(86) PCT No.: PCT/EP2013/069105

§ 371 Date: May 7, 2015

(30) Foreign Application Priority Data
Nov. 15, 2012 (EP) 12192778.4

(51) Int. Cl. E21B 36/04; E21B 33/14; E21B 17/10; H05B 6/36

(52) U.S. Cl. CPC E21B 36/04; H05B 6/36; E21B 33/14; E21B 17/1078

(57) ABSTRACT

An induction apparatus is provided for heating a heavy-oil reservoir The induction apparatus has at least one casing pipe and at least one inductor that is arranged within the casing pipe. An intermediate space is formed between the inductor and the casing pipe. A large number of centring devices are arranged in the intermediate space over the axial profile of the induction apparatus. The centring devices each making contact both with the casing pipe and the inductor. The intermediate space is filled with a filling material.

### RELATED CASES

The present patent document is a §371 nationalization of PCT Application Serial Number PCT/EP2013/069105, filed Sep. 16, 2013, designating the United States, which is hereby incorporated by reference. This patent document also claims the benefit of EP 12192778.4, filed Nov. 15, 2012, which is also hereby incorporated by reference.

### FIELD

The present embodiments relate to an induction apparatus for heating a heavy-oil reservoir as well as to a method for producing an induction apparatus of said type.

### BACKGROUND

It is well-known that new avenues are to be explored in oil production. Thus, it is also well-known that deposits that in the past were not accessible are to be drawn upon for the extraction of oil. Such previously inaccessible oil reservoirs include, for example, so-called heavy-oil reservoirs, in which the heavy oil is present in the earth in dispersed form. In order to enable the heavy oil present in this way to be extracted, it is necessary to heat the heavy oil and thereby lower its viscosity. Different concepts are already being employed for such heating operations. A well-known concept is electrical heating with the aid of induction cables that are laid in the heavy-oil reservoir.

A problematic aspect with the known electrical heating techniques is how to run the induction cable in the heavy-oil reservoir with a minimum amount of effort and at minimum cost. The long-term stability of the induction cable likewise represents a major problem. Thus, it is generally known that a sheathing pipe in the form of a glasfiber reinforced plastic (GRP) tube may be inserted into an existing well or a well drilled into the heavy-oil reservoir. An inductor is introduced through said sheathing pipe, which serves as stability protection. A disadvantageous aspect with this approach is that the inductor lies substantially freely in the interior of the sheathing pipe with direct contact to the sheathing pipe. An increase in temperature of the inductor may occur locally at these contact areas. The temperature increase may lead in an extreme case to overheating of the inductor. The inductor also rubs directly against the sheathing pipe during installation and removal. This may result in mechanical damage to the inductor. It is likewise disadvantageous that cracks in the sheathing pipe may lead to a total lack of leak tightness and accordingly to the destabilization of the induction apparatus.

### SUMMARY AND DETAILED DESCRIPTION

The scope of the present invention is defined solely by the appended claims and is not affected to any degree by the statements within this summary.

An induction apparatus for heating a heavy-oil reservoir as well as a method for producing an induction apparatus is provided. The induction apparatus may be introduced into the earth into the heavy-oil reservoir in a cost-effective and simple manner and at the same time advantageously increase the service life or, as the case may be, the long-term stability of the induction apparatus in use.

Features and details that are described in connection with the induction apparatus are self-evidently applicable also in connection with the method, and vice versa in each case, such that reference is or may always be made to one or the other with respect to the disclosure relating to the individual aspects.

An induction apparatus according to one embodiment serves for heating a heavy-oil reservoir or a different oil reservoir, such as an extra-heavy-oil reservoir or a reservoir containing bitumen deposits. Such an induction apparatus has at least one casing pipe and at least one inductor that is arranged inside the casing pipe. In this configuration, an intermediate space is formed between the inductor, a conductor cable for example, and the casing pipe. An induction apparatus according to the embodiment is characterized in that a plurality of centering devices are arranged in the intermediate space over the axial profile of the induction apparatus. Said centering devices in each case make contact both with the casing pipe and with the inductor. The intermediate space is therein filled with a mechanically stabilizing, in particular electrically insulating, filling material.

In the manner according to one embodiment, a heavy-oil reservoir is arranged in particular in the earth. Thus, for example, a section within a geological formation is saturated or filled with heavy oil, said section forming the heavy-oil reservoir.

In order to gain access to the heavy-oil reservoir, the induction apparatus is introduced into a well. The introduction process is briefly explained below. Thus, after the well has been drilled, the casing pipe is introduced into the well. The casing pipe is in this case embodied with sufficient flexibility to enable the pipe also to be guided along curves in the well. The inductor is subsequently inserted into the casing pipe. Owing to the provision of the plurality of centering devices, which are in contact both with the casing pipe and with the inductor, an intermediate space is formed automatically when the inductor is drawn into the casing pipe. The intermediate space defines a free clearance between the inductor and the casing pipe in the radial direction. After the inductor has been drawn in, said free space, which is formed by the intermediate space, is filled with an electrically insulating filling material, preferably in flowable (e.g., in fluid) form. The filling process may be accomplished by pure gravity feed or with the assistance of pumps or suction equipment. The electrically insulating filling material may be cured directly or indirectly. Indirect curing is to be understood a passive hardening over time. An initial heating by the inductor and the corresponding induction of the surrounding earth may also take place already at this stage in order to cure the filling material at a higher rate and at a lower temperature than when the induction apparatus is employed.

The filling material is a material that, in addition to its electrically insulating property, is flowable in basic form. In said flowable basic form, the filling material may be introduced into the casing pipe and may flow into the intermediate space. Preferably, the filling material is pumpable in its flowable form so that the filling material may be introduced in an assisted manner and consequently at a faster rate. Implicit in the term flowable introduction is naturally also the possibility of using filling materials in powder form, which accordingly are flowable or pourable. A fluid introduction of the filling material and subsequent curing is preferred.

For functionality for mechanical stabilization by the filling material, a transmission of force between the inductor and the filling material is possible during the operation of the induction apparatus. In other words, the filling material, when in use, constitutes a protection against mechanical influence, for example in the form of pressure caused by the surrounding earth. In this respect, the form in which the filling material enters the intermediate space is not important. Thus, materials are possible as filling material that, for example, are poured into the intermediate space as free-flowing bulk material. It is also possible that a flowable embodiment of the material permits the material to be introduced by gravity feed or by pumps, as will be explained later.

It can be of advantage if the centering devices are likewise embodied as electrically insulating. The critical factor is, however, that in an induction apparatus according to one embodiment of the electrical insulation and also the protection in terms of the necessary long-term stability for the inductor against chemical and/or physical influences are provided by the filling material. Accordingly, the casing pipe of an induction apparatus according to the embodiment may be embodied significantly more cost-effectively and, in terms of the choice of material, more simply. The casing pipe is only required to be sufficiently stable in order to be able to serve in the role of formwork while the intermediate space is being filled with the filling material. The subsequent fate of the casing pipe is irrelevant in terms of the functional integrity of the induction apparatus. Thus, the casing pipe may, for example, fracture or even melt while the induction apparatus is being used without this negatively affecting the long-term stability of the inductor and hence of the induction apparatus.

The chosen filling material may be, for example, cement or a similar building material that inherently possesses the necessary mechanical stability and the long-term chemical and/or physical stability to protect the inductor in the manner according to the invention.

The heating by the inductor in respect of the surrounding earth may attain, for example, temperatures of up to approx. 250° C. The centering devices may either be embodied separately from one another or be connected to one another. Thus, for example, a network structure is conceivable that is embodied separately from casing pipe and inductor. In this way, the centering devices may be introduced before the inductor is drawn in. The centering devices thus form a self-contained component. In order to save costs and reduce effort during the installation, it is however advantageous, as will be explained later, if the centering devices are attached to at least one of the two components, namely to the casing pipe and/or to the inductor.

It may of course also be the case that the centering devices are embodied at least in sections as hollow or porous. Thus, the filling material may penetrate at least partially also into said centering devices. It can also be of advantage if the centering devices at least partially dissolve during or after the filling operation and during or prior to the curing of the filling material. Thus, for example, the filling material may be introduced at a temperature that leads to the dissolution of the centering devices. In this way the centering devices are sufficient here for fulfilling the function of embodying and defining the intermediate space before the filling material is introduced. In such an embodiment variant, the centering devices no longer constitute weak points in the envelopment by the filling material. Rather, ultimately, the filling material will substantially fill the intermediate space completely.

It may be advantageous if, in an induction apparatus according to one embodiment, the centering devices, the inductor and/or the filling material possess a temperature stability up to approx. 250° C. It may therefore be the case that all or only one or only parts of said components exhibit a corresponding temperature stability. The usage temperature in terms of the necessary heating by an induction apparatus according to one embodiment preferably lies at approx. 250° C. The casing pipe is not required to exhibit a temperature stability of said kind, since the pipe is needed solely for the embodiment of the induction apparatus. After fulfilling this embodiment function, it is no longer necessary for the casing pipe to provide any further protective functions, which means that a defect of the casing pipe after the curing of the filling material remains of no consequence in terms of the functioning of the induction apparatus.

An induction apparatus according to one embodiment may be developed to the effect that the filling material is a material that has been introduced in flowable form into the intermediate space and cured. As has already been explained in the introduction, the induction apparatus may be produced in a particularly cost-effective and simple manner in this way. In particular, the material is not only flowable, but may also be conveyed by a pump, such that an assistance by force may take place when the filling material is introduced. The curing may be accomplished, for example, by drying and/or by a cross-linking of individual constituent parts of the material. In this way, a physical and/or chemical stability of the filling material is provided that ensures the protection of the inductor.

It is a further advantage if, in an induction apparatus according to one embodiment, the filling material includes at least one of the following materials:
cement,
concrete,
synthetic resin.

The materials enumerated above do not constitute an exhaustive list. In particular, cement or concrete is preferred as the material, because the correlation between the flowability when introducing the material, the rate of curing, and the long-term physical as well as chemical stability are to be seen as particularly favorable. Said filling material may be cured, for example, by a first heating phase at reduced induction power. Thus, a curing temperature may be specified that lies above the ambient temperature or the temperature in situ and below the heating temperature during the conveyance mode of operation of the induction apparatus. In this way, the speed of production of an induction apparatus according to one embodiment is further increased.

It is also advantageous if, in an induction apparatus according to another embodiment, the centering devices form the clearance between the inductor and the casing pipe equally or substantially equally in all radial directions. This means that the clearances or, as the case may be, the intermediate space are/is embodied substantially equidistantly in all radial directions. The equidistant embodiment has the advantage that in this way a uniform heating of the environment may take place owing to the dependence of the heating capacity on the clearance between inductor and the surrounding earth. If an equal or substantially equal clearance is now provided essentially in all radial directions, a substantially equal radially surrounding heating of the earth, and consequently of the heavy-oil reservoir, may also be assumed. This uniform action ensures that the desired lowering of the viscosity of the surrounding heavy oil deposit is realized without an unduly high viscosity being provided at some points and an unduly low viscosity at other points. This equal clearance therefore improves the subsequent conveyability of the heated and consequently viscosity-reduced heavy oil. In particular, this equidistant clearance is also preserved over the axial profile of the induction apparatus, this being achieved, for example, by a corresponding distribution of the centering devices both in the circumferential direction and in the axial direction.

It can likewise be of advantage if, in an induction apparatus according to one embodiment, the inductor has a copper core surrounded by a temperature-resistant insulating layer. In particular said insulating layer includes polyether ether ketone (PEEK) and/or perfluoralkoxy polymers (PFA). The insulating layer serves to provide thermal protection and electrical protection of the copper core in the first step. In this way, it is ensured that no damage to the copper core occurs when the filling material is introduced. An essentially known conductor cable that is available as standard may also be used as an inductor. The temperature resistance of the insulating layer serves to provide additional protection for the copper core and accordingly to reduce the temperature of the copper core when the copper is in use, such that the induction power may be improved as a result of the reduced usage temperature.

A further advantage is achieved if, in an induction apparatus according to another embodiment, the centering devices are embodied as electrically insulating. In particular, the centering devices contain PEEK and/or PFA. Such centering devices may be attached to one of the components, for example, with the aid of an injection molding method. This ensures that the centering devices also do not constitute weak points in the filling material, such that the desired electrical and thermal stability is provided here too.

It may furthermore be advantageous if, in an induction apparatus according to another embodiment, the shape of the centering devices is embodied so as to minimize friction at the contact sections with the inductor and/or with the casing pipe. This results in an improved and simplified insertion of the inductor into the casing pipe. When it is inserted, a relative movement takes place between inductor and centering devices or, as the case may be, between centering devices and casing pipe. Said relative movement is subject to friction due to the contact configuration between the centering devices and the inductor and the casing pipe. The friction-minimized embodiment reduces the frictional forces being generated, such that a simplified and correspondingly force-reduced insertion of the inductor is possible. The friction minimization may be provided, for example, by a reduced contact area or, as the case may be, a reduced contact section. Small surface contacts, linear contacts, or even punctiform or substantially punctiform contacts are preferred. Accordingly, for example, ramp-shaped or spherical heads may be provided as centering devices.

It is likewise of advantage if, in an induction apparatus according to one embodiment, the centering devices are arranged uniformly or substantially uniformly in the circumferential direction and/or in the axial direction of the intermediate space. Distribution is preferably to be understood as a spacing in which two centering devices in each case are spaced apart from one another by an equal or substantially equal distance. The centering devices are preferably arranged in stages or in the manner of a helix in the axial direction. Preferably, the uniform arrangement is effected symmetrically or substantially symmetrically so that the intermediate space may be embodied substantially with equidistant clearances over the entire circumferential profile as well as over the entire axial profile of the induction apparatus. A sagging of the inductor is preferably completely avoided in this way.

It is furthermore advantageous if, in an induction apparatus according to another embodiment, at least some of the centering devices are attached either to the inductor or to the casing pipe. The attachment is completed preferably before the inductor or, as the case may be, the casing pipe is driven into the earth. This enables a preassembly to take place that reduces the effort required when introducing the inductor or casing pipe on site into the heavy-oil reservoir. The attachment may be realized, for example, by adhesive bonds or by direct injection of the centering devices and curing in the desired shape. Accordingly, a correspondingly embodied inductor having centering devices for embodying an induction apparatus according to one embodiment is provided. A casing pipe having centering devices attached on the inside for the purpose of embodying an induction apparatus according to an embodiment is provided.

A further subject matter of another embodiment is a method for producing an induction apparatus. The method includes:
introducing a casing pipe into a well in a heavy-oil reservoir,
inserting an inductor inside the casing pipe, an intermediate space between the casing pipe and the inductor being formed by centering means,
filling the intermediate space with a flowable, curable and in particular electrically insulating filling material, and
curing the filling material.

The casing pipe may be introduced, for example, by mechanical conveyance. The inductor may be, for example, drawn in, in which case a pulling cable that is arranged inside the casing pipe may be used, inter alia. In this case, the inductor is preferably inserted together with the centering devices, which may be attached, for example, to the casing pipe and/or to the inductor. The flowable filling material is then introduced by active conveyance with the aid of pumps or suction equipment or by gravity feed. The electrically insulating filling material may be cured by being heated to an intermediate temperature with the aid of the induction apparatus. Curing over time is also possible.

A method according to one embodiment may be developed to the effect that an induction apparatus according to the embodiment is produced. In this way, the same advantages are achieved as have been explained at length with reference to an induction apparatus according to the invention.

### BRIEF DESCRIPTION OF THE DRAWINGS

The present embodiments are explained in more detail with reference to the attached figures of the drawing. The terms “left”, “right”, “top” and “bottom” used in this context relate to an orientation of the figures of the drawing with normally readable reference signs. In the schematic figures:

FIG. 1 shows a view of an induction apparatus in use,

FIG. 2 shows an embodiment variant of an induction apparatus,

FIG. 3 shows a further embodiment variant of an induction apparatus,

FIG. 4 shows a schematic cross-section through a further embodiment variant of an induction apparatus,

FIG. 5 shows a schematic cross-section through a further embodiment variant of an induction apparatus,

FIG. 6 shows a schematic cross-section through a further embodiment variant of an induction apparatus, and

FIG. 7 shows a schematic lateral cross-section through a further embodiment variant of an induction apparatus.

### DETAILED DESCRIPTION

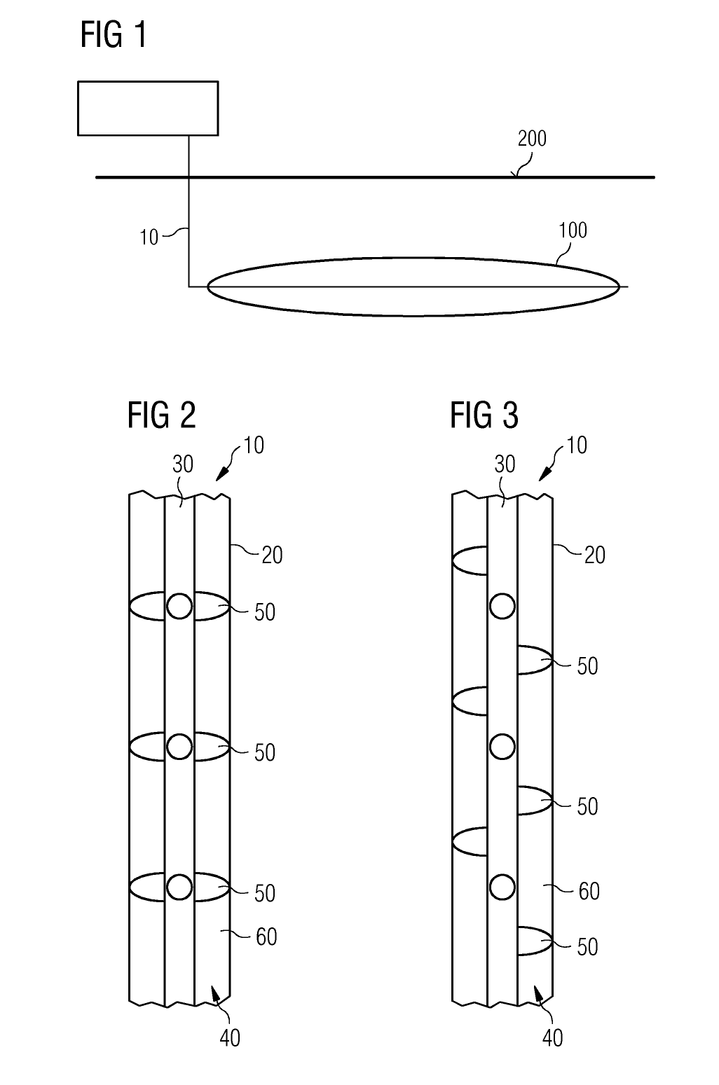

FIG. 1 schematically depicts how an induction apparatus 10 according to one embodiment be used. The induction apparatus 10 is located for the most part below the surface of a geological formation 200 in which a heavy-oil reservoir 100 is arranged. The induction apparatus 10 extends through the heavy-oil reservoir with the greatest longitudinal section in the horizontal direction.

As can be seen from the embodiment variants of FIGS. 2 to 7, the embodiment of the induction apparatus has in each case a centrally arranged inductor 30 in the interior of a casing pipe 20. An intermediate space 40 is formed between the casing pipe 20 and the inductor 30 in each case by a plurality of centering devices 50. As is common to these embodiment variants, the intermediate space 40 is a substantially equidistant clearance between the inductor 30 and the casing pipe 20 in the radial direction.

An induction apparatus 10 according to one embodiment is produced as schematically described below. It may be seen in FIG. 1 that a well drilled in the geological formation 200 takes at least one sharp bend to the right. When the casing pipe 20 is introduced, the casing pipe 20 follows said sharp bend. Accordingly, the casing pipe 20 is embodied with a sufficient degree of flexibility to be inserted in the vertical direction (i.e., from top to bottom) into a borehole and to be turned in a horizontal direction (i.e., from left to right) inside the borehole. The inductor 30 is then introduced such that the already described intermediate space 40 is formed by way of the centering devices 50. A filling material 60 may subsequently be introduced, preferably in flowable form, into the intermediate space 40. The curing of the flowably introduced filling material in the subsequent manner finalizes the production and the production method of the induction apparatus 10. The subsequent fate of the surrounding casing pipe 20 is not relevant to the functioning of the induction apparatus 10, since the physical and/or chemical protection functionality for the inductor 30 is provided by the introduced and cured filling material 60.

FIGS. 2 and 3 show different axial distribution possibilities of the centering devices 50. Thus, a stage-by-stage distribution of the individual centering devices 50 over the axial profile is shown in FIG. 2. FIG. 3 shows a helical axial distribution of the centering devices 50.

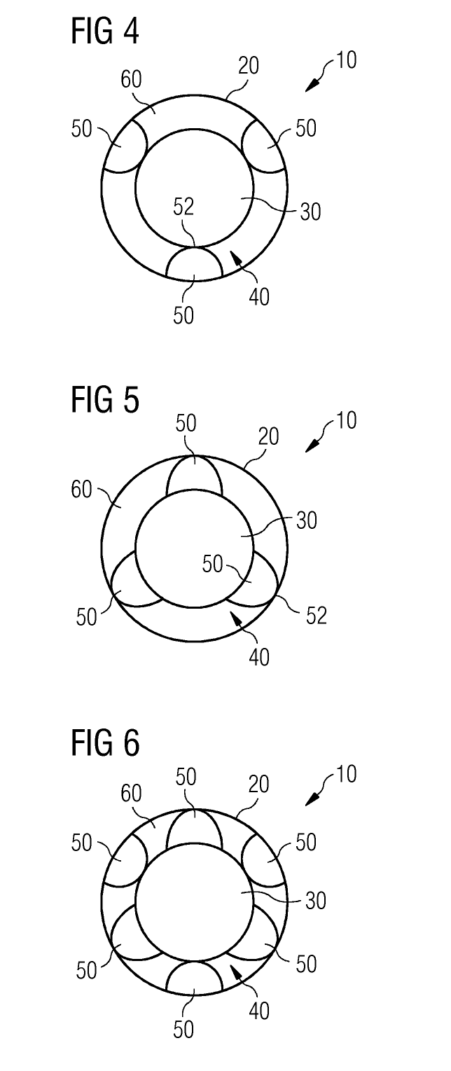

FIGS. 4 to 6 show different arrangement possibilities with different attachments of the centering devices 50. In the embodiment variant shown in FIG. 4, the three centering devices 50 of one stage are attached exclusively to the surrounding casing pipe 20. The contact sections 52 accordingly touch the inductor 30 at their inwardly directed contact section 52 and hold the inductor 30 in the desired position. FIG. 5 shows the reverse embodiment variant, in which the centering devices 50 are attached to the inductor 30 and touch the externally arranged casing pipe 20 by way of contact sections 52. FIG. 6 is the combination of the embodiment variants of FIGS. 4 and 5. In all cases, the flowably introduced and cured filling material 60 is located arranged in the intermediate space 40.

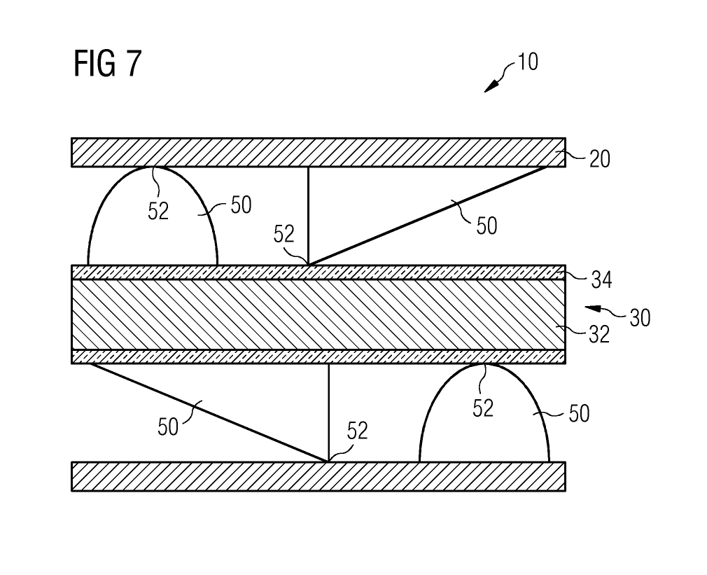

FIG. 7 shows a schematic lateral cross-section where the inductor 30 is embodied with a copper core 32 and an insulating layer 34. In this case, the centering devices 50 may be attached both to the surrounding casing pipe 20 and to the inductor 30. In this case, different shapes of the centering devices 50 are shown. Thus, for example, spherical or elliptical head shaped embodiments of the centering devices 50 may achieve a friction minimization of the contact with the oppositely disposed component. A ramp-shaped structure of the centering devices 50 is also conceivable within the scope of the embodiment.

The inductor used operates according to the following principle:

In order to extract extra-heavy oils or bitumen from the known oil sand or oil shale deposits, it is desirable to increase their flowability considerably. This may be achieved by increasing the temperature of the deposit (reservoir). This temperature increase may in turn be effected by the inductor. Toward that end, individual inductor pairs composed of forward and return conductors or groups of inductor pairs in various geometric configurations, for example, are supplied with current in order to heat the reservoir inductively. Given suitable energization by alternating current, an electromagnetic field forms around the inductor. Said electromagnetic field in turn penetrates into the surrounding earth and excites specific conductive components in the earth (e.g., water or bitumen or hydrocarbons in any other chemical compounds) by electromagnetic induction.

The inductor is effective for inductive electrical heating in respect of at least parts of the deposit. Due to the conductivity of at least parts of the deposit, the latter may be heated by the elements running largely concentrically around the two optimally parallel sections of the inductor. The inductor may be composed in particular of rod-shaped metallic conductors or twisted metallic cables that are made from a highly conductive metal and that are embodied as a resonant circuit in order to generate the electromagnetic field.

The inductor is not a resistive heater, which acts as a mere thermal radiator. The inductor, in contrast, generates no direct thermal energy, but an alternating field that may penetrate into the earth and only there leads to an increase in temperature due to the excitation of particles in the earth.

The explanation of the embodiment variants presented in the foregoing describes the present embodiments exclusively within the context of examples. It goes without saying that individual features of the embodiment variants may be freely combined with one another, to the extent that this is technically beneficial, without departing from the scope of the present invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An induction apparatus for heating an oil reservoir, the inducation apparatus comprising:
at least one casing pipe;
at least one inductor arranged within the casing pipe, wherein an intermediate space is formed between the inductor and the casing pipe;
a plurality of centering devices arranged in the intermediate space over the axial profile of the induction apparatus, said centering devices in each case making contact both with the casing pipe and with the inductor; and
a mechanically stabilizing filling material in the intermediate space.

2. The induction apparatus as claimed in claim 1, wherein the centering devices, the inductor and/or the filling material possess a temperature stability up to approx. 250° C.

3. The induction apparatus as claimed in claim 1, wherein the filling material is a material that is flowably introduced into the intermediate space and cured.

4. The induction apparatus as claimed in claim 1, wherein the filling material includes at least one of the following materials: cement, concrete, or synthetic resin.

5. The induction apparatus as claimed in claim 1, wherein the centering devices form the clearance between the inductor and the casing pipe equally or substantially equally in all radial directions.

6. The induction apparatus as claimed in claim 1, wherein the inductor has a copper core surrounded by a temperature-resistant insulating layer.

7. The induction apparatus as claimed in claim 1, wherein the centering devices comprise electrically insulating material.

8. The induction apparatus as claimed in claim 1, wherein the shape of the centering devices is embodied to minimize friction at contact sections with the inductor and/or with the casing pipe.

9. The induction apparatus as claimed in claim 1, wherein the centering devices are arranged uniformly or substantially uniformly in a circumferential direction and/or in an axial direction of the intermediate space.

10. The induction apparatus as claimed in claim 1, wherein at least some of the centering devices are attached either to the inductor or to the casing pipe.

11. A method for producing an induction apparatus, the method comprising:
introducing a casing pipe into a well in an oil reservoir,
inserting an inductor inside the casing pipe, an intermediate space being formed between the casing pipe and the inductor by centering devices,
filling the intermediate space with a flowable and curable filling material, and
curing the filling material.

12. The method as claimed in claim 11, wherein the centering devices form the clearance between the inductor and the casing pipe equally or substantially equally in all radial directions.

13. The method as claimed in claim 11, further comprising arranging the centering devices uniformly or substantially uniformly in a circumferential direction and/or in an axial direction of the intermediate space.

14. The method as claimed in claim 11, further comprising attaching the centering devices either to the inductor or to the casing pipe.

15. The induction apparatus as claimed 7, wherein the electrically insulating material comprises polyether ether ketone and/or perfluoralkoxy polymers.

16. The induction apparatus as claimed 3, wherein the filling material includes at least one of the following materials: cement, concrete, or synthetic resin.

17. The induction apparatus as claimed 15, wherein the centering devices form the clearance between the inductor and the casing pipe equally or substantially equally in all radial directions.

18. The induction apparatus as claimed 16, wherein the inductor has a copper core surrounded by a temperature-resistant insulating layer.

19. The induction apparatus as claimed 17, wherein the centering devices comprise electrically insulating material.

20. The induction apparatus as claimed 18, wherein the centering devices are arranged uniformly or substantially uniformly in a circumferential direction and/or in an axial direction of the intermediate space.
